(19) United States
(12) Patent Application Publication
(10) Pub. No.: US 2015/0066727 A1
(43) Pub. Date: Mar. 5, 2015

(54) Electronic Trading Exchange with User-Definable Order Execution Delay

(71) Applicant: D. E. Shaw & Co., L.P., New York, NY (US)

(72) Inventors: Eric Karl Wepsic, New York, NY (US); Joshua Edward Engelman, Brooklyn, NY (US)

(73) Assignee: D. E. Shaw & Co., L.P., New York, NY (US)

(21) Appl. No.: 14/013,652

(22) Filed: Aug. 29, 2013

(51) Int. Cl. G06Q 40/04

(52) U.S. Cl. CPC G06Q 40/04
USPC 705/37

(57) ABSTRACT

Exemplary embodiments are related to processing electronic trading orders in an electronic trading exchange environment. Electronic trading orders can be accepted from market participant electronic devices. The electronic trading orders have execution speeds associated therewith that can be used by exemplary embodiments to determine when the electronic trading orders are executed by a matching engine.

### BACKGROUND

Electronic trading exchanges provide a marketplace for the purchase and sale of financial instruments, such as securities, commodities, futures, exchange traded funds (ETFs), mutual funds, and options. Conventionally, these exchanges allow market participants to submit electronic trading orders for execution by a matching engine implemented by the exchange. As a result, most exchanges no longer require human interaction on a “trading floor” to execute a trade transaction. The matching engines implemented by the conventional exchanges can use matching or crossing algorithms to match sell orders with buy orders based on the parameters specified in such orders.

The advent of electronic trading exchanges has spawned a new era in trading in which some market participants use sophisticated automated trading systems. These automated trading systems provide electronic platforms that allow market participants to use algorithms to automatically submit electronic trading instructions (e.g., placement orders or order cancelation requests) to the exchange with minimal or no human intervention. These trading systems are commonly used by institutional investors, mutual funds, broker-dealers, and hedge funds.

In some instances, investors use automated trading systems to implement high-frequency trading (HFT) strategies and/or low-latency strategies to programmatically initiate electronic trading instructions. HFT strategies utilized by investors can generate electronic trading instructions based on information received electronically, often times before conventional traders can process the information. HFT strategies typically buy a quantity of a financial instrument and quickly sell the quantity of the financial instrument within minutes or seconds. Investors that use these HFT strategies can perform many of these transactions in one trading period (e.g., a trading day) and the quantities of the financial instruments bought and sold are typically large (e.g., 100,000 or more shares of a stock).

Low-latency trading strategies utilized by investors to submit electronic trading orders seek to minimize any latencies (e.g., delays) in transmission of electronic trading instructions to an exchange such that electronic trading instructions are transmitted to the exchange within microseconds. Low-latency trading strategies conventionally use ultra-low latency networks and/or have co-located trading platforms in the same facilities as the exchange systems to benefit from implementing high-frequency trading strategies to achieve faster execution times compared to other investors having higher latency systems.

In addition to the latency associated with transmitting an electronic trading instruction to an exchange, each electronic trading instruction received by an electronic trading exchange experiences some delays before being submitted to the exchange's matching engine due to delays inherent in processing the trading instructions. However, these exchange processing delays conventionally have no bias and are intended to be consistent for each received electronic trading instruction. As a result, there is typically an incentive for investors to develop a low-latency trading platform to transmit their electronic trading instructions to the exchange with minimum latency, and thereby attempt to gain an advantage over other investors (i.e., having their electronic trading instruction considered by the exchange's matching engine before electronic trading instructions from other investors).

The recognized advantages of low-latency platforms has led to a low-latency “arms race” in which many investors are continuously deploying new technology to realize lower latency to maintain or establish an advantage over other investors. Such low-latency platforms can be expensive to develop and maintain. This can lead to substantial costs in hardware and software to maintain an advantage. As a result, investors typically expend resources and money to ensure no one has an advantage over them, but once investors have invested in lower latency systems they may each be no better off than they would have been without the investments; indeed, they may be worse off because of the substantial investment expenditures.

### SUMMARY

The present disclosure relates to an electronic trading exchange with user-definable order execution delay features, and methods and computer-readable media relating thereto. In one embodiment, a method of processing electronic trading instructions in an electronic trading exchange environment is provided. The method includes the steps of accepting electronic trading instructions from market participant electronic devices in the electronic trading exchange environment as each of the electronic trading instructions are received from the market participant devices; executing code to determine whether the electronic trading instructions have execution time delays associated therewith as each of the electronic trading instructions are accepted; associating a fee or rebate with each of the electronic trading instructions based on the execution time delays associated therewith; and submitting the electronic trading instructions to a matching engine according to the execution time delays associated therewith.

In another embodiment, the system programmatically accepts an electronic trading instruction from a market participant electronic device in an electronic trading exchange environment, and executes code to determine whether the electronic trading instruction has an execution time delay associated therewith in response to acceptance of the electronic trading instruction. The system then associates a fee or rebate with the electronic trading instruction based on the execution time delay, and executes conditional code to determine whether to submit the electronic trading instruction to a matching engine or to insert the electronic trading instruction into a priority queue before submitting the electronic trading instruction to a matching engine.

Exemplary embodiments advantageously provide a technical solution to reduce incentives that drive market participants to invest in ultra-low-latency infrastructure and to level the playing field for investors. While efficient markets have universal benefit, present conditions provide out-sized rewards to market participants that invest in the next microsecond of reduced latency while conventional investors remain at a potential disadvantage. Exemplary embodiments of the present disclosure seek to curtail the “low-latency arms race” by reducing the impact of low latency trading platforms using a technical solution that limits the usefulness of low latency platforms such that investment in low latency platforms no longer offers a competitive advantage to investors.

Any combination or permutation of embodiments is envisioned. Other objects and features will become apparent from the following detailed description considered in conjunction with the accompanying drawings. It is to be understood, however, that the drawings are designed as an illustration only and not as a definition of the limits of exemplary embodiments of the present disclosure.

### BRIEF DESCRIPTION OF THE DRAWINGS

FIG. 1 is a block diagram of an exchange engine in accordance with exemplary embodiments of the present disclosure.

FIG. 2A is an exemplary execution speed fee schedule for electronic trading order placement instructions in accordance with exemplary embodiments of the present disclosure.

FIG. 2B is an exemplary execution speed fee schedule for electronic trading order cancel request instructions in accordance with exemplary embodiments of the present disclosure.

FIG. 3 is a block diagram of an electronic trading exchange environment in accordance with exemplary embodiments of the present disclosure.

FIG. 4 is a flowchart of an exemplary embodiment of an order handling process implemented by an embodiment of the exchange engine.

FIG. 5 is a flowchart of another exemplary embodiment of an order handling process implemented by an embodiment of the exchange engine.

FIG. 6 is a flowchart of yet another exemplary embodiment of an order handling process implemented by an exemplary embodiment of the exchange engine.

FIG. 7 is a block diagram of an exemplary computing device for implementing embodiments of the exchange auction engine in accordance with exemplary embodiments of the present disclosure.

FIG. 8 is a block diagram of a distributed electronic trading exchange environment in accordance with exemplary embodiments of the present disclosure.

### DESCRIPTION OF EXEMPLARY EMBODIMENTS

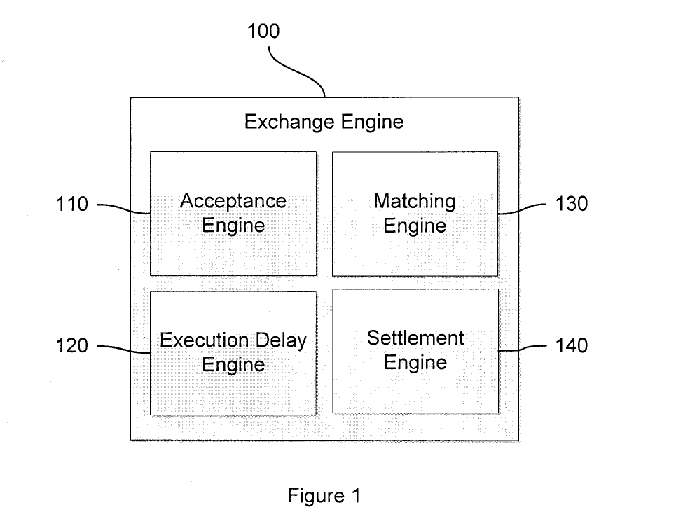

Exemplary embodiments of the present disclosure are related to processing electronic trading instructions (e.g., placement orders and order cancel requests) in an electronic trading exchange environment, as described with respect to FIGS. 1-7. In exemplary embodiments, market participant electronic devices can be in communication with one or more computing devices executing an exchange engine, or portions thereof. The exchange engine can be programmed to allow market participants to submit electronic trading instructions for processing by the exchange engine (e.g., to execute a placement order or cancel a previously submitted placement order).

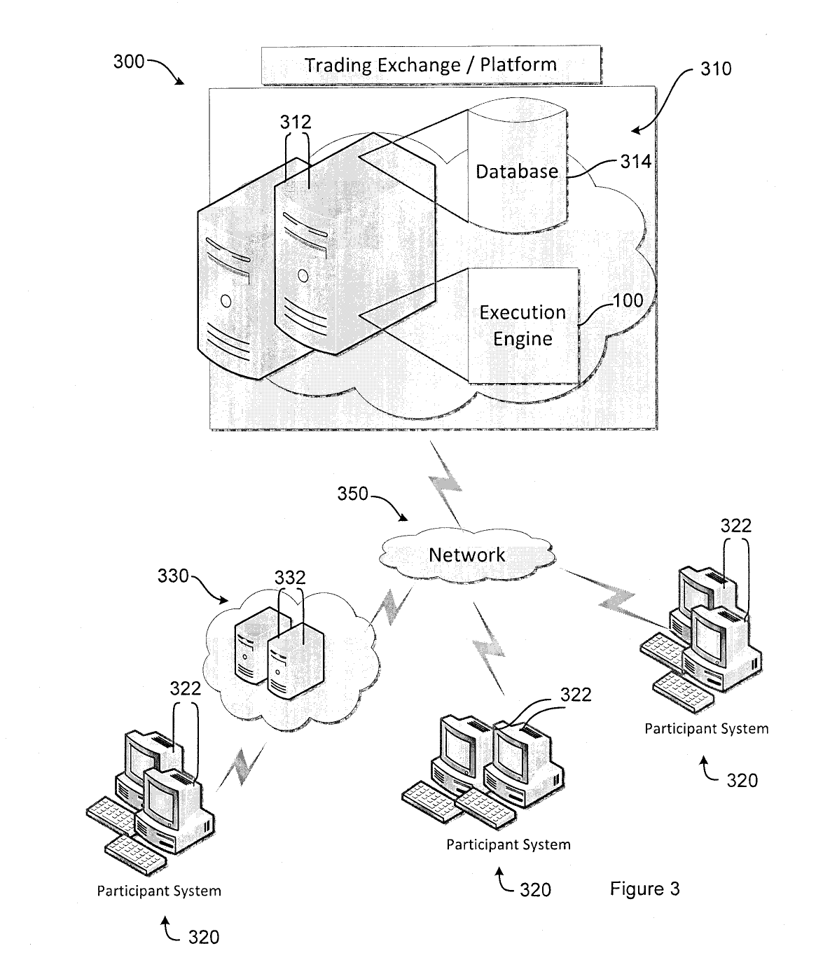

FIG. 1 is a block diagram of an exemplary exchange engine 100. Exemplary embodiments of the engine 100 can be implemented using hardware, software, and/or a combination thereof. For example, in one exemplary embodiment, one or more computing devices, such as one or more servers, can be configured to implement exemplary embodiments of the engine 100. An exemplary embodiment of a computing device programmed and/or configured to implement exemplary embodiments of the engine 100 is shown, for example, in FIGS. 3, 6, and 7, discussed below. The engine 100 can include an acceptance engine 110, an execution delay engine 120, a matching engine 130, and a settlement engine 140.

The engine 100 can be programmed and/or include executable code to implement one or more order handling processes for continuous market trading over a trading period (e.g., a trading day) and/or for periodic auctions of financial instruments throughout the trading period. For embodiments in which period auctions are implemented by the engine 100, the auctions can occur in sequence and/or in parallel with each other. In some embodiments, auctions implemented in accordance with exemplary embodiments can be completed in the order of seconds, minutes, hours, and so on.

Exemplary embodiments of the engine 100 can be implemented as a stand-alone exchange and/or can be incorporated/implemented as part of another exchange, such as the NYSE, NASDAQ, London Stock Exchange, Deutsche Borse, Tokyo Stock Exchange, Chicago Board Options Exchange, Chicago Mercantile Exchange, Chicago Board of Trade, New York Mercantile Exchange, Eurex, LIFFE, and/or any other exchanges.

The acceptance engine 110 can be programmed and/or configured to receive, accept, and maintain electronic trading instructions from market participants. The acceptance engine 110 can be programmed and/or configured to accept different types of electronic trading instructions, such as placement orders (e.g., buy orders, sell orders, put orders, call orders), order cancel request instructions (e.g., request to cancel previously submitted placement orders), and/or any other suitable electronic trading instruction. In one exemplary embodiment, the electronic trading instructions accepted by the engine 110 can be placement orders for selling/buying financial instruments, such as stocks, bonds, commodities, futures, ETFs, mutual funds, options, currencies, swaps, and/or any other suitable items that may be traded in an exchange market.

The electronic trading instructions received from the market participants, via the market participant electronic devices, can include parameters that can be used by the engine 100 when determining how to process the electronic trading orders. Some examples of parameters that can be included in and/or associated with the electronic trading instructions include a limit price parameter, a duration parameter, a quantity (or size) parameter, an instruction type parameter, an execution speed parameter, a participant identifier, and/or any other suitable parameters that can be used by the engine 100 when processing the electronic trading orders. The price parameter identifies a price at which the market participant will buy or sell the financial instrument (e.g., a dollar amount or market price). The duration parameter identifies a time period over which the order will be valid (e.g., guaranteed until cancelled, one day, one week, one auction cycle, etc.). The quantity parameter identifies a quantity of the financial instruments the market participant wishes to buy or sell (e.g., 100 shares of a stock). The instruction type parameter identifies the type of instruction being submitted by the market participant (e.g., a market order, a limit order, a buy order, a sell order, order cancel request, and/or any other instruction types). The execution speed parameter identifies when to submit an electronic trading instruction to the matching engine 130 (e.g., immediately upon receipt by the engine 100 or after one or more time delays). The participant identifier provides an identity of the market participant that is submitting the electronic trading order. In exemplary embodiments, the participant identifier can be, for example, a username, an account number, an IP address, a MAC address, a business name, a string of alphanumeric character, and/or any other suitable identifiers that can be used to distinguish between different market participants.

The execution delay engine 120 can be programmed to determine execution times of electronic trading orders (i.e., the times at which the electronic trading orders are submitted to the matching engine 130). The execution times can be determined by the engine 120 based on the execution speed parameter included in and/or associated with the electronic trading instructions. The execution speed parameter can specify whether an electronic trading instruction should be delivered to the matching engine 130 without a time delay after the electronic trading instruction is accepted or whether a time delay should be applied to the electronic trading instruction after the electronic trading instruction is accepted such that a time at which the electronic trading instruction is submitted to the matching engine 130 is delayed by a specified amount of time.

In exemplary embodiments, the execution delay engine 120 can create and/or maintain a priority queue for accepted electronic trading instructions having associated execution time delays. The execution delay engine 120 can programmatically review electronic trading instructions (e.g., placement orders, order cancel requests, etc.) accepted by the acceptance engine 110 and can add those electronic trading instructions to the priority queue when the engine 120 determines that an execution time delay is associated with the electronic trading instruction. In some embodiments, if the engine 120 determines that there is no execution time delay associated with an electronic trading instruction, the engine 120 can submit the electronic trading instruction directly to the matching engine 130.

As electronic trading instructions are added to the priority queue, the execution delay engine 120 determines a position of the electronic trading instructions in the priority queue based on their associated execution time delay so that the sequence of the trading instructions in the priority queue corresponds to a sequence in time that the electronic trading instructions will be submitted to the matching engine 130. The time an electronic trading order waits in the priority queue is determined by the corresponding execution time delay associated with the electronic trading order.

The matching engine 130 can be programmed and/or configured to receive each of the electronic trading instructions according to the specified execution speeds (e.g., execution time delay, if any) associated with the electronic trading instructions. The matching engine 130 programmatically attempts to match received electronic trading instructions for placement orders with other electronic trading orders in its limit order book (e.g., a collection of orders submitted to the matching engine awaiting execution) and/or attempts to cancel placement orders in the order book when the received electronic trading instructions correspond to order cancel requests. The matching engine 130 programmatically matches placement orders with other placement orders by applying one or more matching priority rules to the electronic trading placement orders in an order book maintained by the matching engine 130. For example, the matching engine 130 can programmatically match placement orders based on a price-time matching algorithm, a price-size priority matching algorithm, a price-participant-time matching algorithm, and/or any other suitable matching algorithm.

The price-time matching gives matching priority to placement orders based on a price specified in the electronic trading orders and the time and sequence that the placement orders are delivered to the matching engine 130. In an exemplary embodiment, electronic trading instructions can be continuously submitted to the matching engine 130 either via the priority queue or directly if no execution time delay is specified. The electronic trading instructions from the priority queue can be applied to the limit order book of the matching engine 130 in the sequence defined by the priority queue and at the time determined based on the execution time delays associated with the electronic trading instructions in the priority queue. The electronic trading instructions are processed by the matching engine 130 as the trading instructions are received by the matching engine, where the electronic trading instructions in the priority queue can be processed in sequence according to their relative positions in the priority queue. As electronic trading instructions are received by the matching engine 130, either from the priority queue or directly when no execution time delay is specified, the matching engine 130 can identify whether the electronic trading instructions are placement orders or order cancel requests. If the matching engine 130 determines that the trading instruction corresponds to a placement order, the matching engine 130 attempts to execute the placement order by attempting to match a resting order or orders in the limit order book (e.g., buy orders specifying a price that is greater than the lowest sell order price already present in the limit order book) with the placement order. If the matching engine 130 determines that the trading instruction corresponds to an order cancel request, the matching engine 130 attempts to cancel the corresponding placement order in the limit order book.

The price-size priority matching algorithm is similar to price-time matching except that matching priority is given to resting orders in the limit order book based on their order size (e.g., a value of the quantity parameter in the electronic trading orders) rather than their arrival time (e.g., the time at which the placement orders are received by the matching engine 130). For example, when the matching engine 130 considers matching an incoming sell order against a number of buy orders in the limit order book at a given limit price, the matching engine 130 can give priority to orders in the limit order book having a smaller size. Alternatively, matching priority can be given to placement orders in the limit order book having a larger size. Alternatively, matching may be performed pro-rata where a fraction of the sell order is matched against each of the eligible buy orders in the limit order book at the given limit price in proportion to the size of each buy order.

The price-participant-time matching is similar to price-time matching, but incorporates participant information when processing the electronic trading instructions. For example, when the matching engine 130 considers an incoming sell order against a number of resting buy orders in the limit order book at a given limit price, the matching engine 130 may give priority to resting buy orders with the same participant identifiers as the incoming sell order.

In some embodiments, the matching engine 130 may implement a periodic single-price auction whereby the matching engine accepts a set of electronic trading instructions during a period of time and then selects a price at which the maximum quantity of shares can be crossed between buyers and sellers. In an exemplary embodiment, the matching engine 130 may provide a time window for submission of electronic trading instructions during which electronic trading instructions from the priority queue may be delivered to the matching engine 130 at the time determined by each instructions' execution time delay. The matching engine 130 may include only those electronic trading instructions from the priority queue whose execution time delay has expired as of the end of matching engine 130's auction acceptance period, even if those instructions have been received by acceptance engine 110 before the end of the auction acceptance period. For example, if an electronic trading instruction arrives at acceptance engine 110 40 milliseconds (ms) before the end of the auction acceptance period and is associated with an execution time delay of 50 ms, then this trading instruction may be excluded from the auction. In some embodiments, this instruction may be delivered to the matching engine according to the time determined by the instruction's execution time delay for a subsequent auction or matching process, or may be cancelled.

The settlement engine 140 can create and/or maintain one or more execution speed schedules and can be programmed and/or configured to associate specified execution speeds with a fee/rebate for the execution speed. For example, in one embodiment, electronic trading instructions associated with faster execution speeds (i.e., lower execution time delays) can be assessed a fee, while electronic trading instructions with slower execution speeds (i.e., higher execution time delays) can receive a rebate. In some embodiments, execution speed fees can be charged for electronic trading instructions (e.g., placement orders or order cancel requests) requesting preferential execution speed regardless of whether the electronic trading instructions are executed (e.g., filled by matching the placement order with other placement orders in the order book). In some embodiments, rebates may only be paid for electronic trading instructions that are executed (e.g., participants cannot earn rebates by simply placing and cancelling orders that are never filled).

In some embodiments, an execution speed schedule can be created and/or maintained for electronic trading instructions related to buying financial instruments, electronic trading instructions related to selling financial instruments, electronic trading instructions related to canceling previously submitted placement orders, and/or any combination thereof. As one example, an execution speed schedule can be created and/or maintained for electronic trading placement orders (e.g., buying and selling financial instruments), and an execution speed schedule can be created and/or maintained for canceling electronic trading placement orders previously submitted to the engine 100 (e.g., order cancel requests). In some embodiments, the execution speed schedules can be different for different financial instruments. As one example, higher-priced securities can have different execution speed schedules than low-priced securities. As another example, different types of financial instruments can have different execution speed schedules (e.g., stocks can have different execution speed schedules than bonds). In some embodiments, the settlement engine 140 can be programmed and/or configured to dynamically create and/or modify the execution speed schedule.

In some embodiments, a structure of the execution speed schedule(s) can be limited. As an example, a first execution speed schedule for placement orders (e.g., buying/selling financial instruments) can be limited to be symmetrical to a second execution speed schedule for order cancel request (e.g., canceling placement orders previously submitted). That is, a fee/rebate associated with a particular execution time delay in the first execution speed schedule can be identical to the fee/rebate applied for the same execution time delay in the second execution speed schedule. Establishing symmetry between execution speed schedules can reduce and/or eliminate opportunities for market participants to exploit the execution speed schedules. For example, if a 50 ms delay placement order is free and a 25 ms delay placement order costs 0.05 cents per share (c/share), but a 25 ms delay order cancel request is free, then this asymmetry can incentivize participants to place 50 ms delayed placement orders and cancel them within 25 ms rather than paying a fee for 25 ms delay placement orders.

In some embodiments, the relationship between the execution speed (e.g., corresponding to the execution time delay) and the fee/rebate for such execution speeds as defined by the execution speed schedules can be governed by information received and/or generated by the settlement engine 140. For example, the engine 140 can be programmed and/or configured to create and/or modify execution speed schedules based on the information received and/or generated by the engine 140.

In some embodiments, the information used to create and/or modify the execution speed schedules can include information about quantiles of specified execution speeds over a given historical period (e.g., the most recent month). The quantiles can be examined and the execution speed schedule can be set such that the total fees charged for higher speed quantiles are equal to or slightly more than rebates provided to participants requesting the lowest speed quantiles. A maximum distance between the highest and lowest fee rate can be some fraction of a typical bid-ask spread of financial instruments trading in a given price band.

In some embodiments, the information used to create and/or modify the execution speed schedules can include information about short-term post-trade returns of orders requesting the faster execution speeds relative to those requesting slower execution speeds. The returns can be analyzed and the fee/rebate rates of the execution speed schedules can be set such that the difference between the returns can be negated (or nearly negated).

In some embodiments, the information used to create and/or modify the execution speed schedules can include information corresponding to a total value of orders historically placed at each requested execution speed. The total value can be analyzed and pricing for each level can be set to maximize the total value of orders placed in each price level.

The settlement engine 140 can create and/or maintain transaction logs. The transaction logs can include a record of fees/rebates associated with electronic trading instructions accepted by the engine 100. The settlement engine 140 can be programmed and/or configured to use the transaction log when collecting fees assessed and distributing rebates. In exemplary embodiments, the settlement engine 140 can be configured to charge fees associated with corresponding electronic trading instructions when the electronic trading instructions are accepted and/or at some time after the electronic trading instructions have been accepted (e.g., at the termination of the trading period). In exemplary embodiments, the settlement engine 140 can be programmed to distribute rebates after corresponding electronic trading instructions have been filled (i.e., executed) by the matching engine 130. In some embodiments, rebates earned by a market participant can be accumulated and distributed at the end of the trading period.

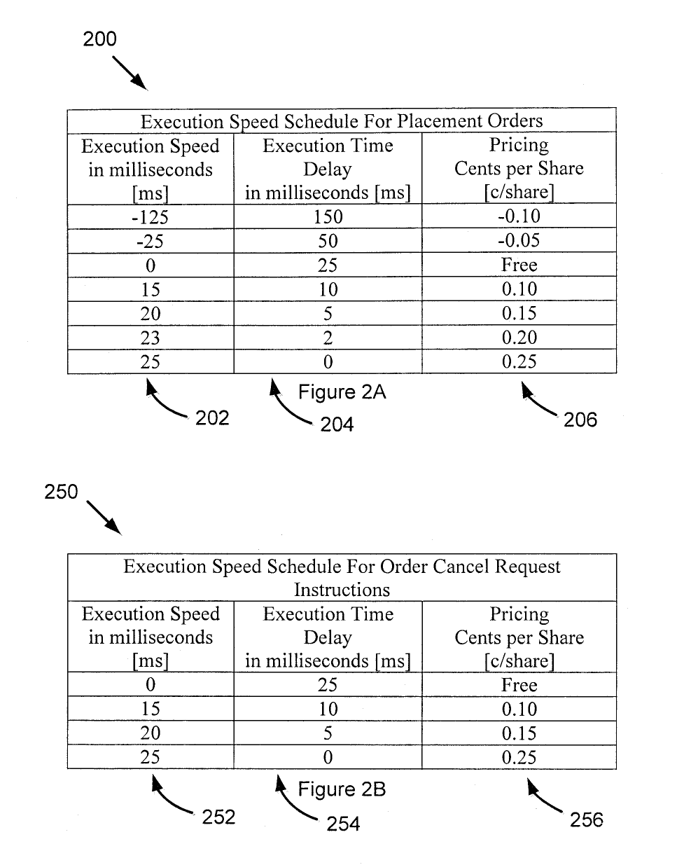

FIGS. 2A and 2B show exemplary execution speed schedules 200 and 250, respectively, in accordance with one embodiment of the present disclosure. The schedule 200 corresponds to an execution speed schedule for electronic trading placement orders (i.e., orders to buy or sell a financial instrument) and the schedule 250 corresponds to an execution speed schedule for electronic order cancel requests. The schedules 200 and 250 can specify execution speeds 202 and 252, execution time delays 204 and 254, and pricing 206 and 256, respectively.

In the present embodiment, the schedule 200 can include execution speeds (e.g., 25 ms, 23 ms, 20 ms, 15 ms, 0 ms, −25 ms, and −125 ms) that can be associated with execution time delays 204 (e.g., 0 ms, 2 ms, 5 ms, 10 ms, 25 ms, 50 ms, and 150 ms, respectively) and can be associated with the corresponding pricing 206 (e.g., 0.25 c/share, 0.20 c/share, 0.15 c/share, 0.10 c/share, free, −0.05 c/share (i.e., a rebate/discount), and −0.10 c/share, respectively). According to the schedule 200, a market participant is charged a fee when submitting electronic placement orders having an execution speed that is greater than zero (e.g., an execution time delay that is less than 25 ms). If a market participant submits an electronic placement order having an execution speed of zero (e.g., an execution time delay of 25 ms), the market participant is neither charged a fee nor due a rebate/discount on the electronic placement order. For electronic placement orders having an associated execution speed that is less than zero (e.g., an execution time delay that is greater than 25 ms), a rebate/discount is paid to the market participant if the electronic placement order is executed (i.e., the matching engine 130 matches the electronic trading order with another electronic trading order).

In the present embodiment, the schedule 250 is generally symmetrical to the schedule 200 (i.e., the identical delays have the same pricing). As shown in FIG. 2B, the schedule 200 can include execution speeds 252 (e.g., 25 ms, 20 ms, 15 ms, and 0 ms) that can be associated with execution time delays 254 (e.g., 0 ms, 5 ms, 10 ms, and 25 ms, respectively), and can be associated with the corresponding pricing 256 (e.g., 0.25 c/share, 0.15 c/share, 0.10 c/share, and free, respectively). According to the schedule 250, a market participant is charged a fee when submitting electronic order cancel requests having an execution speed that is greater than zero (e.g., an execution time delay that is less than a 25 ms). If a market participant submits an electronic order cancel request having an execution speed of zero (e.g., an execution time delay of 25 ms), the market participant is neither charged a fee nor due a rebate/discount on the electronic trading order. While the present embodiment of the schedules 200 and 250, shown in FIGS. 2A and 2B, are generally symmetrical, those skilled in the art will recognize that embodiments of the schedules 200 and 250 can be asymmetrical (i.e., identical delays in different schedules may have different pricing). Furthermore, while the schedules 200 and 250 define execution speeds 202 and 252 as distinct values compared to execution time delays 204 and 254, respectively, those skilled in the art will recognize that the execution speed and the execution time delays can be the same such that separate execution speeds and execution delay times are not required in the schedules 200 and 250.

FIG. 3 depicts an exemplary electronic trading exchange environment 300. The environment 300 includes electronic trading exchange platform 310 that includes one or more computing devices configured as one or more servers 312, as well as one or more databases 314, and market participant systems 320 that can include, for example, one or more market participant electronic devices, which can be computing devices programmed and/or configured to interact with the trading exchange platform 310. The market participant systems 320 can be communicatively coupled to the trading exchange platform 310 via a communications network 350. The communication network 350 can be the Internet, an intranet, a virtual private network (VPN), a wide area network (WAN), a local area network (LAN), and the like. The environment 300 can be configured to implement continuous market trading and/or one or more periodic electronic auctions to allow market participants, via the electronic devices 322, to sell and/or buy financial instruments, such as, for example, stocks, bonds, commodities, futures, ETFs, mutual funds, options, currencies, swaps, and/or any other suitable items that may be traded in an exchange market.

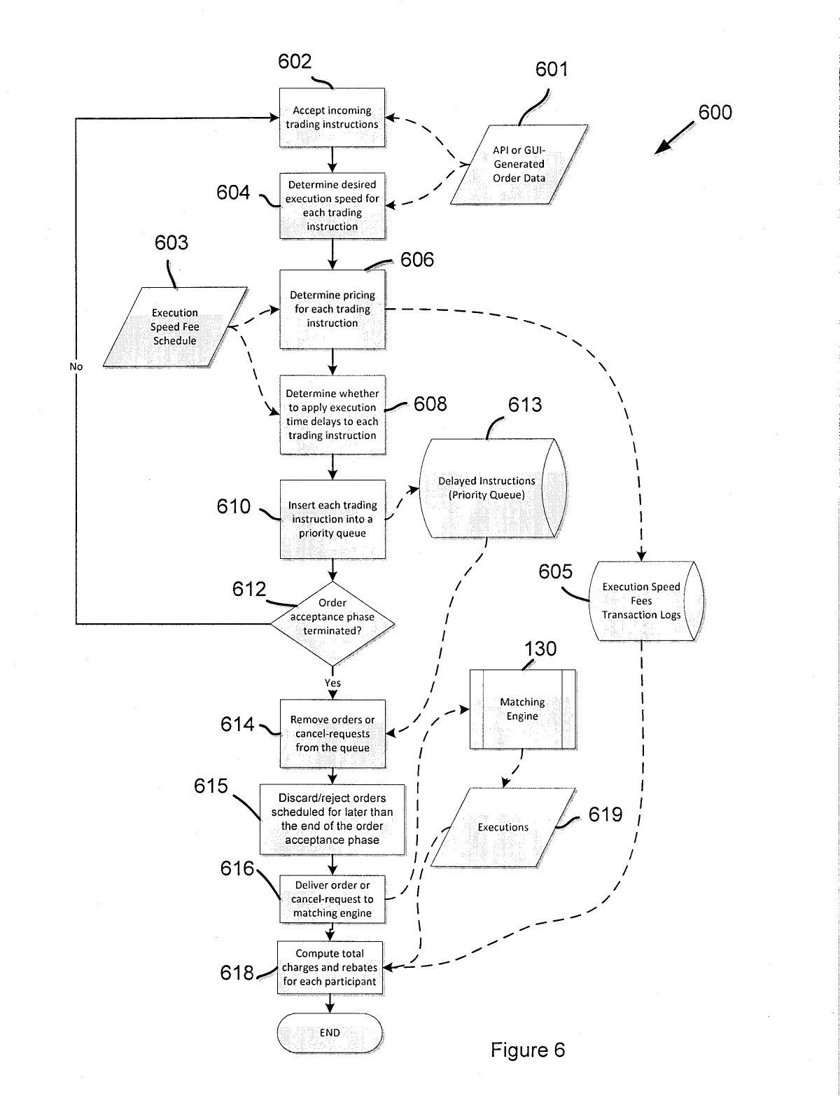

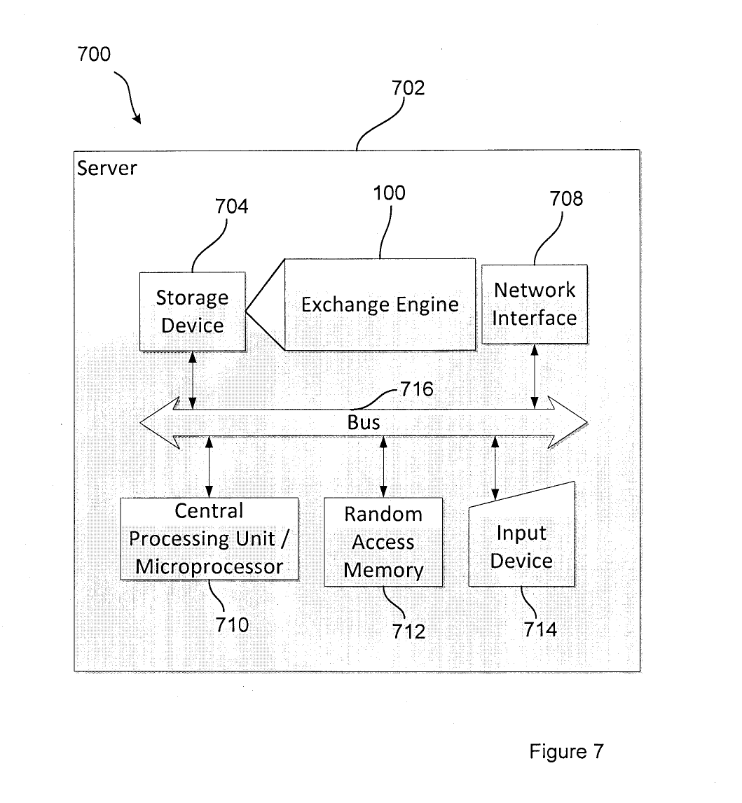

At least one of the servers 312 associated with the electronic trading exchange platform 300 can be programmed to execute an embodiment of the exchange engine 100. An exemplary embodiment of a computing device configured as a server for executing the exchange engine 100 is shown in FIG. 6. In some embodiments, portions of the exchange engine 100 can be distributed across the servers 312, as shown in FIG. 7. Referring to FIG. 3, the databases 314 can store the electronic trading instructions received by the electronic trading exchange platform 310, instruction execution information, execution speed schedules, and/or any other information that can be used to implement exemplary embodiments of the present disclosure. The order execution information can include, for example, instruction execution results, market participants associated with the electronic trading instructions accepted by the engine 100, delays applied to the electronic trading instructions, and/or any other auction information that can be used to implement the auctions in accordance with exemplary embodiments or to maintain a record of auctions previously implemented by the trading exchange platform 300.

In exemplary embodiments, the market participant systems 320 can be associated with one or more hedge funds, brokerages, financial institutions, investment banks, institutional investors, trustees, fund managers, individual investors, and/or any other entities that may wish to participate in one or more auctions implemented by trading exchange platform 310. The computing devices configured as market participant electronic devices 322 can be implemented as, for example, a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein. In exemplary embodiments, some of the electronic devices 322 can include a client-side application that is programmed and/or configured to facilitate interaction (in some instances via an application program interface (API)) between the electronic devices 322 and the trading exchange platform 310. In some embodiments, the client-side application can be a web-browser configured to navigate to a web page hosted by or programmed to interface with the trading exchange platform, which allows the market participants to submit their electronic trading instructions. In some embodiments, the client-side application can be a software application specific to the trading exchange platform 310.

In some embodiments, one of the market participant systems 320 can include electronic devices that are programmed and/or configured to interact with an intermediary system 330, which can include one or more servers 332 programmed and/or configured to communicate with the trading exchange platform 310 on-behalf of the market participant system 320. For example, a market participant can submit an electronic trading instruction to the intermediary system 330 via one of the electronic devices 322 and the intermediary system 330 can process and forward the electronic trading instructions to the trading exchange platform 310. In some embodiments, the intermediary system 330 can correspond be, for example, a broker-dealer system.

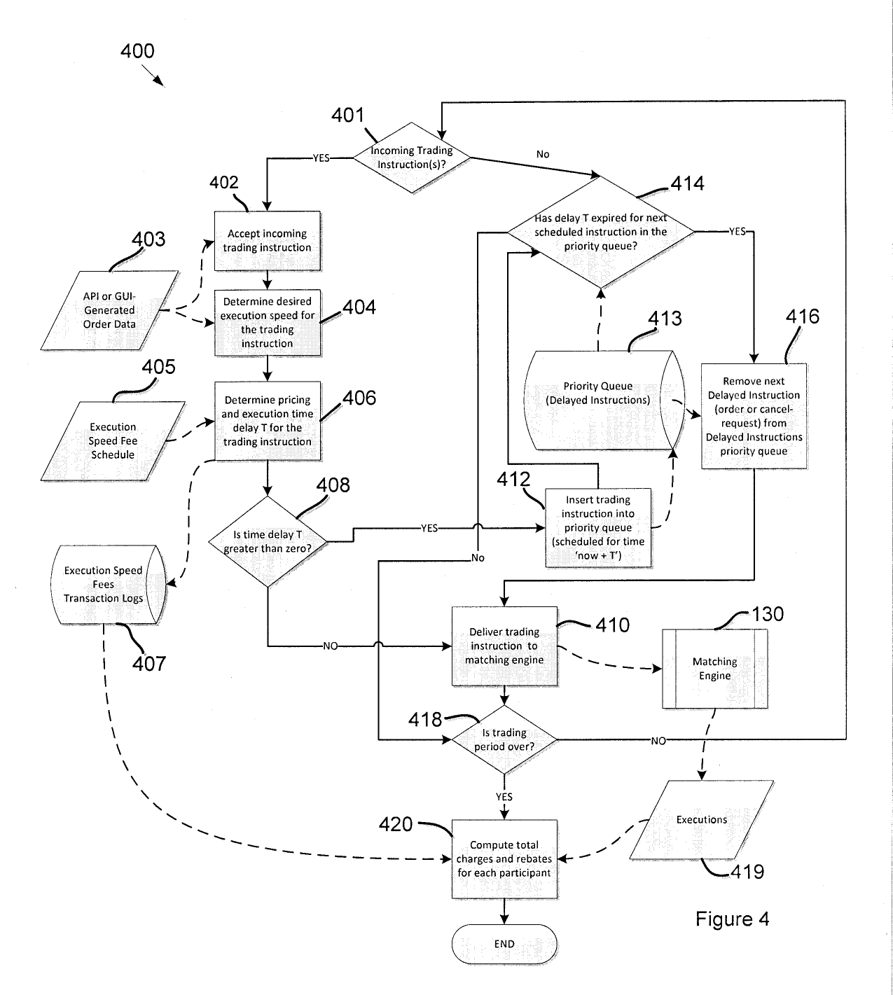

FIG. 4 is a flowchart of an exemplary order handling process 400 that can be implemented by an exemplary embodiment of the engine 100 being executed, for example, as part of an embodiment of the electronic trading environment 300. The order handling process 400 can implement a continuous auction. Initially, the process 400 determines in step 401 whether an incoming trading instruction exists. If so, step 402 occurs; otherwise, step 414 (discussed below) occurs. At step 402, the engine 100 can be programmed and/or configured to continuously accept electronic trading instructions (e.g., placement orders and/or order cancel requests) from a market participant (e.g., via market participant electronic devices executing an API to the engine 100 and/or a graphical user interface (GUI) associated with the engine) (collectively referred to as 403). The engine 100 can be configured to accept and process the electronic trading instructions as the electronic trading instructions are received by the engine 100. The electronic trading instructions can have associated parameters used by the engine 100 to execute the electronic trading instructions. In an exemplary embodiment, electronic trading instructions accepted by the engine 100 can be associated with execution speeds.

At step 404, the engine 100 can determine an execution speed associated with an electronic trading instruction accepted by the engine 100, for example, by programmatically extracting a value from the execution speed parameter in the electronic trading instruction, and at step 406, the engine 100 can retrieve one or more execution speed schedules 405 to programmatically determine an execution time delay and a fee or rebate associated with the specified execution speed based on the schedule(s). In exemplary embodiments, the execution speed schedules can be statically or dynamically defined. In some embodiments the execution speed schedules can be defined based on information ascertained by the engine 100, which can be programmed to process the information to create and/or modify the execution speed schedules.

The engine 100 determines whether to apply an execution time delay to the execution of the electronic trading instruction based on the specified execution speed and maintains a transaction log 407 to associate electronic trading instructions with associated fees/rebates. If there is no execution time delay to apply (step 408), the engine 100 delivers the electronic trading instruction to the matching engine 130 at step 410 and the matching engine 130 attempts to match the electronic trading order with other electronic trading orders. If there is an execution time delay to apply (step 408), the engine 100 inserts the electronic trading instruction into the priority queue 413 at step 412. The engine 100 can perform steps 402-412 for each newly accepted electronic trading instruction.

At step 414, the engine 100 identifies the next electronic trading instruction in the priority queue and determines whether the execution time delay has expired for the electronic trading instruction. If the execution time delay has not expired, the engine 100 determines if the trading period is over at step 418, and if it is not over, control passes back to step 401. Process 400 has the effect of a “busy waiting” for either a new incoming trading instruction or the delay to have expired for the next scheduled instruction, or for the trading period to end. While the present embodiment uses a “busy waiting” approach, those skilled in the art will recognize that exemplary embodiments can implement different schemes, such as a Unix select call or a semaphore wait command. Further, it is noted that termination conditions, such as the end of the trading period, can also be handled at other points in FIG. 4 and at junctions throughout the diagram.

In some embodiments, the engine 100 can operate in parallel such that the engine 100 can concurrently monitor delay of the next order in the priority queue and can continue to accept and process electronic trading instructions (e.g., continue to add newly accepted trading instructions having an associated execution time delay to the priority queue and/or continue submitting newly accepted electronic trading instructions without associated execution time delays to the matching engine 130). Once the execution time delay for the next electronic trading instruction in the priority queue has expired, the engine 100 can remove the electronic trading instruction from the queue at step 416 and can deliver the electronic trading instruction to the matching engine 130 at step 410. If the matching engine 130 determines that the trading instruction corresponds to a placement order, the matching engine 130 attempts to execute the placement order by attempting to match a resting order or orders in the limit order book (e.g., buy orders specifying a price that greater than the lowest sell order price already present in the limit order book) with the placement order. If the matching engine 130 determines that the trading instruction corresponds to an order cancel request, the matching engine 130 attempts to cancel the corresponding placement order in the limit order book.

If the trading period has not expired (step 418), the engine 100 continues to implement the process 400 by accepting and processing electronic trading instructions and retrieving electronic trading instructions from the priority queue. Once the trading period has expired, the engine 100 can retrieve a record of instruction executions 419 (e.g., filled placement orders and/or successfully canceled placement orders) from the matching engine 130 and can retrieve the transaction log 407 maintained by the settlement engine 140, and the engine 100 (e.g., via the settlement engine 140) can compute the total charges and rebates for each market participant at step 420. In exemplary embodiments, the engine 100 can be programmed and/or configured to compute a total charges value for each participant based on fees associated with requested execution speeds for accepted electronic trading instructions associated with the market participant and can compute a total rebate value based on rebates associated with requested execution speeds for executed electronic trading instructions associated with the market participant using the execution speed schedule(s) 405.

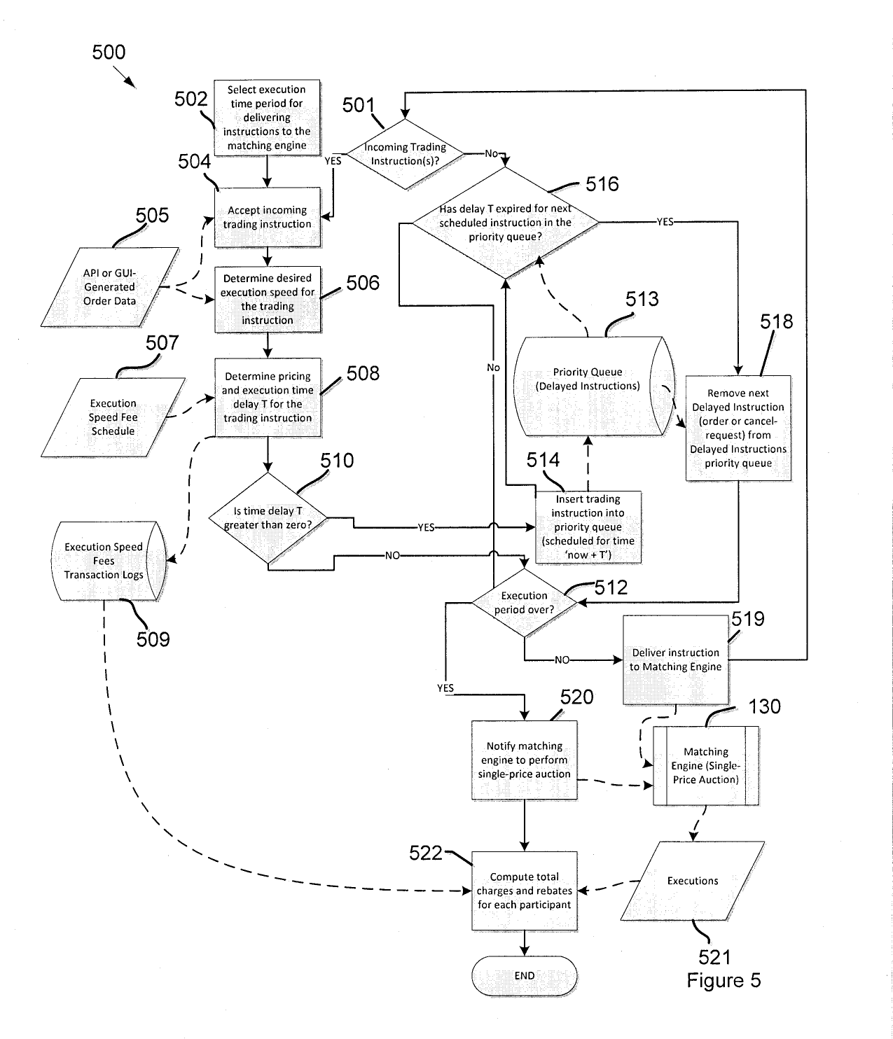

FIG. 5 is a flowchart of another exemplary order handling process 500 that can be implemented by an exemplary embodiment of the engine 100 being executed, for example, as part of an embodiment of the electronic trading environment 300. The order handling process 500 can implement a single clearing price call auction. To begin, at step 502, the engine 100 can be programmed and/or configured to select an execution time period for delivering electronic trading instructions to the matching. A determination is made in step 501 as to whether an incoming trading instruction exists. If so, step 504 occurs; otherwise, step 516 (discussed below) occurs. At step 504, the engine 100 can be programmed and/or configured to continuously accept electronic trading instructions (e.g., placement orders and/or order cancel request) from a market participant during an order execution period. In an exemplary embodiment, electronic trading instructions accepted by the engine 100 can be associated with execution speeds. At step 506, the engine 100 can determine an execution speed associated with an electronic trading instruction accepted by the engine 100, as described herein, and at step 508, the engine 100 can retrieve one or more execution speed schedules 507 to programmatically determine an execution time delay and a fee or rebate associated with the specified execution speed based on the schedule(s), which can be specified as described herein.

The engine 100 determines whether to apply an execution time delay to the execution of the electronic trading instruction based on the specified execution speed and maintains a transaction log 509 to associate electronic trading instructions with associated fees/rebates. If there is no execution time delay to apply (step 510), the engine 100 determines whether the execution time period has expired (e.g., whether the matching engine 130 has ceased matching received orders) at step 512. If the execution time period has not expired, the engine 100 delivers the electronic trading instruction to the matching engine 130 at step 520 and the matching engine 130 implementing a double auction attempts to match the electronic trading order with other electronic trading orders. If the execution time period has expired, any electronic trading instructions received by the engine 100 that have not already been delivered to the matching engine 130 are not subject to execution by the matching engine 130 and the process 500 proceeds to step 522 discussed below. If there is an execution time delay to apply (step 510), the engine 100 inserts the electronic trading instruction into the delay queue 513 at step 514. The engine 100 can perform steps 504-514 for each newly accepted electronic trading instruction.

At step 516, the engine 100 identifies the next electronic trading instruction in the delay queue and determines whether the execution time delay has expired for the electronic trading instruction. If the execution time delay has not expired, step 512 occurs. Process 500 has the effect of a “busy waiting” for either a new incoming trading instruction or the delay to have expired for the next scheduled instruction or the execution period to end. While the present embodiment uses a “busy waiting” approach, those skilled in the art will recognize that exemplary embodiments can implement different schemes, such as a Unix select call or a semaphore wait command. Further, it is noted that additional termination conditions, such as the end of the trading period, can also be handled in FIG. 5 and at junctions throughout the diagram.

In some embodiments, the engine 100 can operate in parallel such that the engine 100 can concurrently monitor delay of the next order in the delay queue and can continue to accept and process electronic trading instructions (e.g., continue to add newly accepted trading instructions having an associated execution time delay to the delay queue and/or continue submitting newly accepted electronic trading instructions without associated execution time delays to the matching engine 130).

Once the execution time delay for the next electronic trading instruction in the delay queue has expired, the engine 100 can remove the electronic trading instruction from the queue at step 518 and proceeds to step 512 at which point the engine 100 determines whether the execution time period has expired. If the execution time period has not expired, the engine 100 delivers the electronic trading instruction retrieved from the delay queue to the matching engine 130 at step 519. If the execution time period has expired, engine 100 notifies the matching engine 130 at step 520 to perform the single-price auction for which the matching engine 130 selects a single clearing price that maximizes the quantity of shares that can be crossed between buyers and sellers. The matching engine 130 attempts to match the electronic trading instructions received by the matching engine 130 before the expiration of the execution time period according to the single clearing price when the execution time period expires.

As described above, the engine 100 continues to implement the process 500 by accepting and processing electronic trading instructions and retrieving electronic trading instructions from the delay queue until the execution time period expires. In the present embodiment, the matching engine 130 may include only those electronic trading instructions from the delay queue whose execution time delay has expired prior to the expiration of the execution time period, even if those instructions are received by acceptance engine 110 before the end of the execution time period. For example, if an electronic trading instruction arrives at acceptance engine 110 40 ms before the end of the execution time period and is associated with execution time delay 50 ms, then this trading instruction may be excluded from the auction. In some embodiments, this instruction may be delivered to the matching engine 130 according to the time determined by the instruction's execution time delay for a subsequent auction or matching process, or may be cancelled.

Once the execution time period has expired, and the matching engine 130 matches the electronic trading instructions according to the single clearing price, the engine 100 can retrieve a record of instruction executions 521 (e.g., filled placement orders and/or successfully canceled placement orders) from the matching engine 130 and can retrieve the transaction log 509 maintained by the settlement engine 140, and the engine 100 (e.g., via the settlement engine 140) can compute the total charges and rebates for each market participant at step 522. In exemplary embodiments, the engine 100 can be programmed and/or configured to compute a total charges value for each participant based on fees associated with requested execution speeds from for accepted electronic trading instructions associated with the market participant and can compute a total rebate value based on rebates associated with requested execution speeds from for executed electronic trading instructions associated with the market participant using the execution speed schedule(s) 507.

FIG. 6 is a flowchart of another exemplary instruction handling process 600 that can be implemented by an exemplary embodiment of the engine 100 being executed, for example, as part of an embodiment of the electronic trading environment 300. The order handling process 600 can implement a call auction using a continuous matching algorithm. At step 602, the engine 100 can be programmed and/or configured to continuously accept electronic trading instructions from a market participant during an order acceptance phase of a periodic call auction (e.g., via market participant electronic devices executing an API to the engine 100 and/or a GUI) (collectively referred to as 601). The electronic trading instructions can have associated parameters used by the engine 100 to execute the electronic trading instructions. In an exemplary embodiment, each electronic trading instruction accepted by the engine can be associated with an execution speed (e.g., specified in or associated with the electronic trading instruction via the execution speed parameter).

At step 604, the engine 100 can determine the execution speed associated with an electronic trading instruction accepted by the engine 100, for example, by programmatically extracting a value from the execution speed parameter in the electronic trading instruction the engine 100 can retrieve one or more execution speed schedules 603 to programmatically determine a pricing associated with the specified execution speed at step 606 based on the schedule(s). At step 608, the engine 100 can programmed to determine an execution time delay associated with the specified execution speed at step 606 based on the schedule(s). In exemplary embodiments, the execution speed schedules can be statically or dynamically defined. In some embodiments the execution speed schedules can be defined based on information ascertained by the engine 100, which can be programmed to process the information to create and/or modify the execution speed schedules.

At step 608, the engine 100 determines whether to apply an execution time delay to the execution of the electronic trading instruction based on the specified execution speed and maintains a transaction log 605 to associate electronic trading instructions with associated fees/rebates. If there is no execution time delay to apply, the engine 100 inserts the electronic trading instruction into the priority queue 613 at step 610 based on the time the electronic trading instruction was accepted by the engine 100. If there is an execution time delay to apply, the engine 100 inserts the electronic trading instruction into the priority queue 613 at step 610 based on the time the electronic trading was accepted by the engine offset by the execution time delay. As an example, two electronic trading instructions can be accepted consecutively by the engine 100, where the first electronic trading instruction accepted by the engine 100 is associated with an execution time delay and the second electronic trading instruction accepted by the engine has no associated execution delay. Because the second electronic trading instruction has no execution time delay it is placed in the queue in front of the first electronic trading instruction which has an associated execution time delay.

After the instruction acceptance phase terminates (step 612), the electronic trading instructions in the priority queue 613 can be removed in sequence at step 614 according to their position in the queue. In step 615, the system discards/rejects orders scheduled for later than the end of the order acceptance phase, and in step 616 remaining instructions are delivered to the matching engine 130 in the sequence defined by the queue (discarding or rejecting any instructions scheduled in the queue with an execution time later than the time at which the order acceptance phase ends). The matching engine 130 can attempt to match placement orders with other placement order in the order book according to the sequence in which the placement orders are received and/or can attempt to cancel placement orders.

At the end of the auction, the engine 100 can retrieve a record of trade executions 619 from the matching engine 130 and can retrieve the transaction log 605 maintained by the settlement engine 140, and the engine 100 (e.g., via the settlement engine 140) can compute the total charges and rebates for each market participant at step 620. In exemplary embodiments, the engine 100 can be programmed and/or configured to compute a total charges value for each participant based on fees associated with requested execution speeds from for accepted electronic trading instructions associated with the market participant and can compute a total rebate value based on rebates associated with requested execution speeds from for executed electronic trading instructions associated with the market participant using the execution speed schedule(s) 603.

FIG. 7 is a diagram showing hardware and software components of an exemplary system 700 capable of performing the processes discussed above. The system 700 includes a processing server 702 (e.g., a computer), which can include a storage device 704, a network interface 708, a communications bus 716, a central processing unit (CPU) 710 (e.g., a microprocessor), a random access memory (RAM) 712, and one or more input devices 714 (e.g., a keyboard or a mouse). The processing server 702 can also include a display (e.g., a liquid crystal display (LCD) or a cathode ray tube (CRT)). The storage device 704 can include any suitable, computer-readable storage medium (e.g., a disk, non-volatile memory, read-only memory (ROM), erasable programmable ROM (EPROM), electrically-erasable programmable ROM (EEPROM) or flash memory). The processing server 702 can be, for example, a networked computer system, a personal computer, a smart phone or a tablet.

The engine 100, or portions thereof, can be embodied as computer-readable program code stored on one or more non-transitory computer-readable storage device 704 and can be executed by the CPU 710 using any suitable, high or low level computing language (such as, e.g., Java, C, C++, C#, .or NET). Execution of the computer-readable code by the CPU 710 can cause the engine 100 to implement embodiments of one or more processes. The network interface 708 can include, for example, an Ethernet network interface device, a wireless network interface device, or any other suitable device which permits the processing server 702 to communicate via the network. The CPU 710 can include any suitable single- or multiple-core microprocessor of any suitable architecture that is capable of implementing and/or running the engine 100 (e.g., an Intel processor). The random access memory 712 can include any suitable, high-speed, random access memory typical of most modern computers (e.g., dynamic RAM (DRAM)).

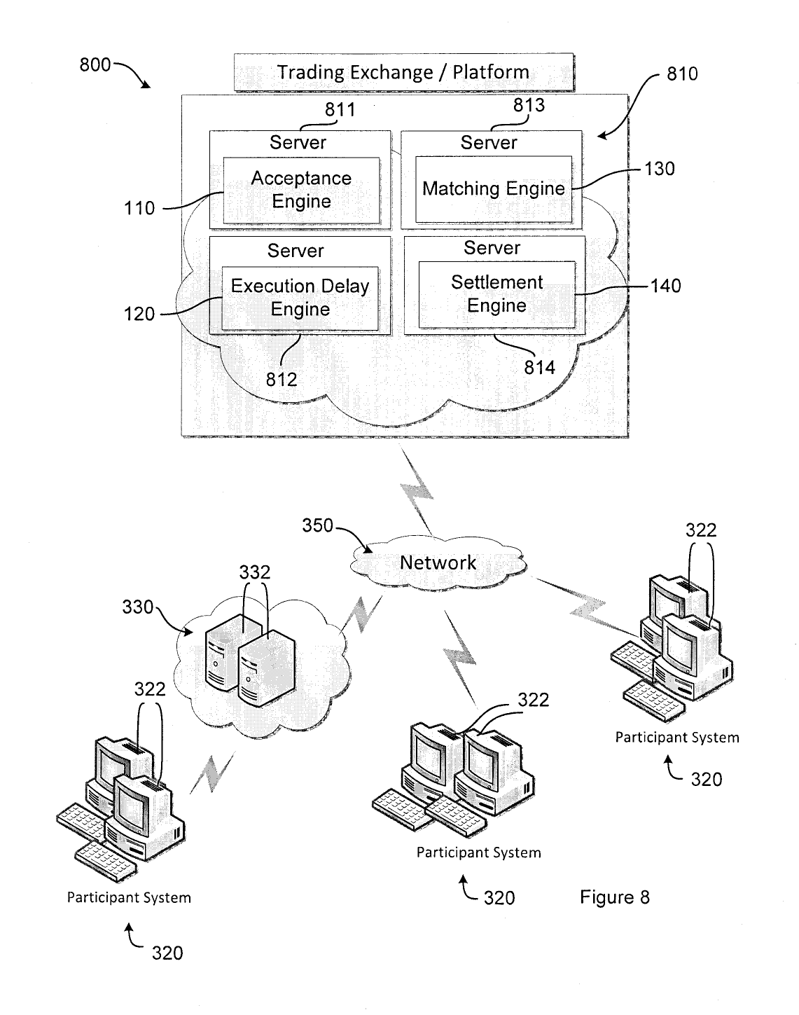

FIG. 8 is a block diagram of a distributed electronic trading exchange environment 800 in accordance with exemplary embodiments of the present disclosure. As shown in FIG. 8, an exemplary embodiment of the exchange engine 100 can be distributed across servers 811-814 associated with a trading exchange platform 810. For example, the server 811 can include acceptance engine 110, the server 812 can include the execution delay generator 120, the server 813 can include the matching engine 130, and the server 814 can include the settlement engine 140. The servers 811-814 can be communicatively coupled to facilitate interaction between the servers 811-814 to implement one or more order handling processes of the engine 100. The electronic devices 222 associated with the auction systems 220 can be communicatively coupled to the trading exchange platform 810 via the network 250 to facilitate an interaction between the market participant systems 220 and the trading exchange platform 810 as described herein. In some embodiments the market participant systems 220 can interface with the trading exchange platform through the intermediary system 230.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A method of processing electronic trading instructions in an electronic trading exchange environment comprising:
programmatically accepting an electronic trading instruction from a market participant electronic device in the electronic trading exchange environment;
executing code to determine whether the electronic trading instruction has an execution time delay associated therewith in response to acceptance of the electronic trading instruction;
associating a pricing with the electronic trading instruction based on the execution time delay; and
executing conditional code to determine whether to submit the electronic trading instruction to the matching engine or to insert the electronic trading instruction into a priority queue before submitting the electronic trading instruction to a matching engine,
wherein the electronic trading instruction is submitted to the matching engine if the execution time delay associated therewith is zero and inserted into the priority queue if the execution time delay associated therewith is greater than zero.

2. The method of claim 1, wherein a position of the electronic trading instruction in the priority queue is determined based on a time at which the electronic trading instruction is accepted and the execution time delay.

3. The method of claim 1, further comprising:
executing code to remove the electronic trading instruction from the priority queue in response to an expiration of the execution time delay; and
submitting the electronic trading instruction to the matching engine, the matching engine being programmed to apply the electronic trading instruction against other electronic trading instruction in an order book maintained by the matching engine.

4. The method of claim 1, wherein executing code to determine whether the electronic trading instruction has an execution time delay associated therewith comprises:
programmatically retrieving an execution speed schedule from storage;
comparing an execution speed parameter associated with the electronic trading instruction to the execution speed schedule;
identifying the execution time delay corresponding to the execution speed parameter; and
associating the execution time delay with the electronic trading instruction.

5. The method of claim 1, wherein associating a pricing with the electronic trading instruction comprises:
programmatically retrieving an execution speed schedule from storage;
comparing an execution speed parameter associated with the electronic trading instruction to the execution speed schedule;
identifying the pricing corresponding to the execution speed parameter; and
storing the pricing associated with the electronic trading instruction in a transaction log.

6. The method of claim 5, further comprising:
determining that a trading period in electronic trading exchange environment has expired;
retrieving executed transaction information from the matching engine;
retrieving pricing information from the transaction log;
computing a total fee for submitted electronic trading instructions requesting a preferential execution speed based on the pricing information for a market participant associated with the electronic trading instruction;
computing a total rebate for executed electronic trading instructions requesting an inferior execution speed based on the execution transaction information for the market participant; and
determining whether the total fee exceeds the total rebate for each market participant,
wherein a difference between the total cost and the total rebate is collected if the total cost exceeds the total rebate or the difference is distributed if the total rebate exceeds the total fee.

7. A non-transitory computer-readable medium storing instruction executable by a processing device in an electronic trading exchange environment, wherein execution of the instructions by the processing device causes processing of electronic trading orders in the electronic trading exchange environment, the processing comprising:
programmatically accepting an electronic trading instruction from a market participant electronic device in the electronic trading exchange environment;
executing code to determine whether the electronic trading instruction has an execution time delay associated therewith in response to acceptance of the electronic trading instruction;
associating a pricing with the electronic trading instruction based on the execution time delay; and
executing conditional code to determine whether to submit the electronic trading instruction to the matching engine or to insert the electronic trading instruction into a priority queue before submitting the electronic trading instruction to a matching engine,
wherein the electronic trading instruction is submitted to the matching engine if the execution time delay associated therewith is zero and inserted into the priority queue if the execution time delay associated therewith is greater than zero.

8. The medium of claim 7, wherein a position of the electronic trading instruction in the priority queue is determined based on a time at which the electronic trading instruction is accepted and the execution time delay.

9. The medium of claim 7, wherein execution of the instructions by the processing device causes processing of electronic trading orders comprising:
executing code to remove the electronic trading instruction from the priority queue in response to an expiration of the execution time delay; and
submitting the electronic trading instruction to the matching engine, the matching engine being programmed to apply the electronic trading instruction against other electronic trading instruction in an order book maintained by the matching engine.

10. The medium of claim 7, wherein executing code to determine whether the electronic trading instruction has an execution time delay associated therewith comprises:
programmatically retrieving an execution speed schedule from storage;
comparing an execution speed parameter associated with the electronic trading instruction to the execution speed schedule;
identifying the execution time delay corresponding to the execution speed parameter; and
associating the execution time delay with the electronic trading instruction.

11. The medium of claim 7, wherein associating a pricing with the electronic trading instruction comprises:
programmatically retrieving an execution speed schedule from storage;
comparing an execution speed parameter associated with the electronic trading instruction to the execution speed schedule;
identifying the pricing corresponding to the execution speed parameter; and
storing the pricing associated with the electronic trading instruction in a transaction log.

12. The medium of claim 11, wherein execution of the instructions by the processing device causes processing of electronic trading orders comprising:
determining that a trading period in electronic trading exchange environment has expired;
retrieving executed transaction information from the matching engine;
retrieving pricing information from the transaction log;
computing a total fee for submitted electronic trading instructions requesting a preferential execution speed based on the pricing information for a market participant associated with the electronic trading instruction;
computing a total rebate for executed electronic trading instructions requesting an inferior execution speed based on the execution transaction information for the market participant; and
determining whether the total fee exceeds the total rebate for each market participant,
wherein a difference between the total cost and the total rebate is collected if the total cost exceeds the total rebate or the difference is distributed if the total rebate exceeds the total fee.

13. A system of processing electronic trading orders in an electronic trading exchange environment comprising:
at least one storage device storing instructions for an order handling process;
a processing device communicatively coupled to the at least one storage device, the processing device being programmed to execute the instructions to:
accept an electronic trading instruction from a market participant electronic device in the electronic trading exchange environment;
determine whether the electronic trading instruction has an execution time delay associated therewith in response to acceptance of the electronic trading instruction;
associate a pricing with the electronic trading instruction based on the execution time delay; and
determine whether to submit the electronic trading instruction to the matching engine or to insert the electronic trading instruction into a priority queue before submitting the electronic trading instruction to a matching engine,
wherein the electronic trading instruction is submitted to the matching engine if the execution time delay associated therewith is zero and inserted into the priority queue if the execution time delay associated therewith is greater than zero.

14. The system of claim 13, wherein a position of the electronic trading instruction in the priority queue is determined based on a time at which the electronic trading instruction is accepted and the execution time delay.

15. The system of claim 13, wherein the processing device is programmed to execute the instructions to:
remove the electronic trading instruction from the priority queue in response to an expiration of the execution time delay; and
submit the electronic trading instruction to the matching engine, the matching engine being programmed to apply the electronic trading instruction against other electronic trading instruction in an order book maintained by the matching engine.

16. The system of claim 13, wherein the processing device determines whether the electronic trading instruction has an execution time delay associated therewith by:
retrieving an execution speed schedule from storage;
comparing an execution speed parameter associated with the electronic trading instruction to the execution speed schedule;
identifying the execution time delay corresponding to the execution speed parameter; and
associating the execution time delay with the electronic trading instruction.

17. The system of claim 13, wherein the processing device associates a pricing with the electronic trading instruction by:
retrieving an execution speed schedule from storage;
comparing an execution speed parameter associated with the electronic trading instruction to the execution speed schedule;
identifying the pricing corresponding to the execution speed parameter; and
storing the pricing associated with the electronic trading instruction in a transaction log.

18. The system of claim 17, wherein the processing device is programmed to execute the instructions to:
determine that a trading period in electronic trading exchange environment has expired;
retrieve executed transaction information from the matching engine;
retrieve pricing information from the transaction log;
compute a total fee for submitted electronic trading instructions requesting a preferential execution speed based on the pricing information for a market participant associated with the electronic trading instruction;
compute a total rebate for executed electronic trading instructions requesting an inferior execution speed based on the execution transaction information for the market participant; and
determine whether the total fee exceeds the total rebate for each market participant,
wherein a difference between the total cost and the total rebate is collected if the total cost exceeds the total rebate or the difference is distributed if the total rebate exceeds the total fee.

19. A method of processing electronic trading instructions in an electronic trading exchange environment comprising:
accepting electronic trading instructions from market participant electronic devices in the electronic trading exchange environment as each of the electronic trading instructions are received from the market participant devices;
executing code to determine whether the electronic trading instructions have execution time delays associated therewith as each of the electronic trading instructions are accepted;
associating a pricing with each of the electronic trading instructions based on the execution time delays associated therewith; and
submitting the electronic trading instructions to a matching engine according to the execution time delays associated therewith.

20. The method of claim 19, further comprising:
receiving the electronic trading instructions from the market participant device during an order acceptance phase of a call auction;
programmatically inserting each of the electronic trading instructions into a priority queue to define a sequence, a position of each of the electronic trading orders in the sequence being determined based on a time at which each of the electronic trading instructions are accepted and the execution time delays associated therewith.
executing code to remove the electronic trading instructions from the priority queue according to the sequence after the order acceptance phase terminates; and
submitting the electronic trading instructions to a matching engine as the electronic trading instructions are removed from the priority queue, the matching engine being programmed to apply the electronic trading instructions against other electronic trading instructions in an order book maintained by the matching engine.

21. The method of claim 20, further comprising:
determining that the auction is complete;
retrieving executed transaction information from the matching engine;
retrieving pricing information from a transaction log;
computing a total fee for each of the electronic trading instructions accepted during the order acceptance phase that requested a preferential execution speed based on the pricing information;
computing a total rebate for each of the electronic trading instructions matched to other electronic trading instructions that requested an inferior execution speed based on the execution transaction information.
